(19) United States
(12) Patent Application Publication
(10) Pub. No.: US 2026/0285180 A1
(43) Pub. Date: Sep. 24, 2026

(54) VEHICLE, CONTROL METHOD, AND STORAGE MEDIUM FOR CONTACTLESS POWER TRANSMISSION SYSTEM

(71) Applicant: HONDA MOTOR CO., LTD., Tokyo (JP)

(72) Inventors: Kosuke KAJITA, Tokyo (JP); Yasuo NAKAGAWA, Tokyo (JP)

(73) Assignee: HONDA MOTOR CO., LTD., Tokyo (JP)

(21) Appl. No.: 19/570,181

(22) Filed: Mar. 18, 2026

(30) Foreign Application Priority Data
Mar. 19, 2025 (JP) 2025-044455

(51) Int. Cl. B60L 53/38; B60G 17/0165; B60G 17/019; B60L 53/124; B60L 53/126; B60L 53/36

(52) U.S. Cl. CPC B60L 53/38; B60G 17/0165; B60G 17/01908; B60L 53/124; B60L 53/126; B60L 53/36; B60L 2240/10

(57) ABSTRACT

A vehicle for a contactless power transmission system that performs contactless power transmission between a vehicle-side unit mounted on the vehicle and a ground-side unit provided outside the vehicle includes a battery, the vehicle-side unit electrically connected to the battery, a suspension disposed between a wheel and a vehicle body, and a control device including a processor that controls the vehicle-side unit and the suspension. The processor acquires information on a relative position between the vehicle-side unit and the ground-side unit, and controls the suspension to tilt the vehicle-side unit with respect to the ground-side unit when the relative position deviates from a predetermined target position.

### CROSS-REFERENCE TO RELATED APPLICATIONS

This application is based on and claims priority under 35 USC 119 from Japanese Patent Application No. 2025-044455 filed on Mar. 19, 2025, the entire content of which is incorporated herein by reference.

### TECHNICAL FIELD

The present disclosure relates to a vehicle, a control method, and a non-transitory computer-readable storage medium storing a program for a contactless power transmission system that transmits power between a vehicle-side unit and a ground-side unit in a contactless manner.

### BACKGROUND ART

In recent years, in order to allow more people to access affordable, reliable, sustainable, and advanced energy, researches and developments have been conducted on charging and power supply in a mobility mounted with a secondary battery that contributes to an increase in energy efficiency. For example, US10399449B2 discloses a technique for performing contactless power transmission between a power transmission pad provided on the ground and a power reception pad mounted on a vehicle.

In the technique disclosed in US10399449B2, when a foreign object is present on the ground or when the ground is not flat, a suspension is adjusted such that the vehicle-side power reception pad is parallel to the ground-side power transmission pad. Accordingly, contactless power transmission efficiency is improved.

### SUMMARY OF INVENTION

For example, when a vehicle stop position is limited due to an environment around a ground-side unit, a positional deviation between a vehicle-side unit and the ground-side unit may occur. In such a case, there is still room for consideration of a technique for improving contactless power transmission efficiency.

Aspect of non-limiting embodiments of the present disclosure relates to providing a vehicle, a control method, and a non-transitory computer-readable storage medium storing a program for a contactless power transmission system that can improve power transmission efficiency when a vehicle-side unit and a ground-side unit are positioned with a positional deviation.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided a vehicle for a contactless power transmission system that performs contactless power transmission between a vehicle-side unit mounted on the vehicle and a ground-side unit provided outside the vehicle, the vehicle including a battery, the vehicle-side unit electrically connected to the battery, a suspension disposed between a wheel and a vehicle body, and a control device including a processor that controls the vehicle-side unit and the suspension, in which the processor acquires information on a relative position between the vehicle-side unit and the ground-side unit, and controls the suspension to tilt the vehicle-side unit with respect to the ground-side unit when the relative position deviates from a predetermined target position.

According to an aspect of the present disclosure, there is provided a control method for a contactless power transmission system that transmits power in a contactless manner between a vehicle-side unit mounted on a vehicle and a ground-side unit provided outside the vehicle, the control method including acquiring, by a processor, information on a relative position between the vehicle-side unit and the ground-side unit, and controlling, by the processor, a suspension of the vehicle to tilt the vehicle-side unit with respect to the ground-side unit when the relative position deviates from a predetermined target position.

According to an aspect of the present disclosure, there is provided a non-transitory computer-readable storage medium storing a program for a contactless power transmission system causing a computer to perform processing, the contactless power transmission system transmitting power in a contactless manner between a vehicle-side unit mounted on a vehicle and a ground-side unit provided outside the vehicle, the processing including acquiring information on a relative position between the vehicle-side unit and the ground-side unit; and controlling a suspension of the vehicle to tilt the vehicle-side unit with respect to the ground-side unit when the relative position deviates from a predetermined target position.

According to the present disclosure, power transmission efficiency can be improved when the vehicle-side unit and the ground-side unit are positioned with a positional deviation.

### BRIEF DESCRIPTION OF DRAWINGS

Exemplary embodiment(s) of the present invention will be described in detail based on the following figures, wherein:

FIG. 1 is a schematic configuration diagram of a contactless power transmission system according to an exemplary embodiment of the present invention;

FIG. 2 is a functional block diagram of the contactless power transmission system;

FIG. 3 is a functional block diagram of a control system of a vehicle;

FIG. 4 is a conceptual diagram showing tilt control for the vehicle, in which an upper diagram shows a state before the tilt control and a lower diagram shows a state after the tilt control; and

FIG. 5 is a flowchart of the tilt control by a processor of the vehicle.

### DESCRIPTION OF EMBODIMENTS

Hereinafter, an embodiment of a vehicle, a control method, and a non-transitory computer-readable storage medium storing a program for a contactless power transmission system of the present disclosure will be described with reference to the accompanying drawings. The drawings are viewed in directions of reference signs. In the present specification and the like, in order to simplify and clarify the description, in the drawings, a front side of a vehicle is shown as Fr, a rear side is shown as Rr, a left side is shown as L, a right side is shown as R, an upper side is shown as U, and a lower side is shown as D.

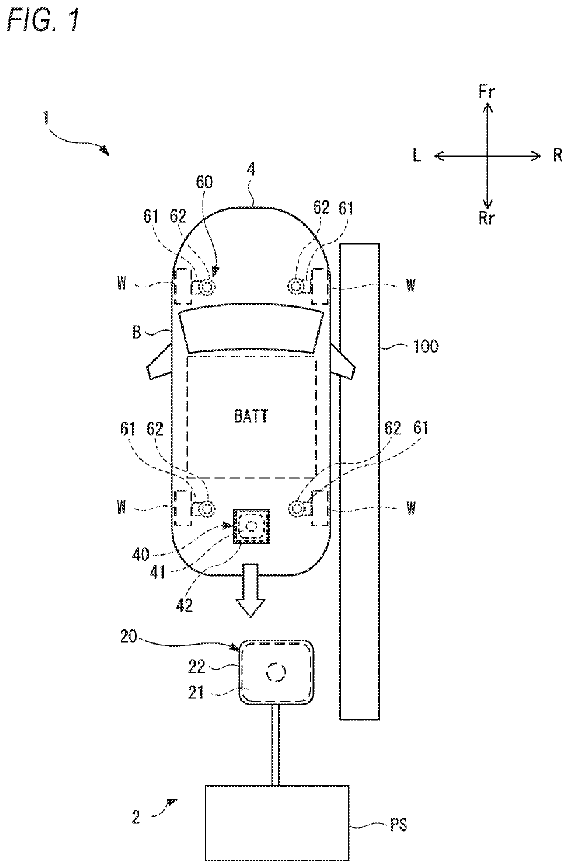

FIG. 1 is a schematic configuration diagram of a contactless power transmission system 1 according to an exemplary embodiment of the present invention. The contactless power transmission system 1 includes ground-side equipment 2 where a ground-side unit 20 is provided, and a vehicle 4 where a vehicle-side unit 40 is mounted. In FIG. 1, reference sign 100 denotes an obstacle that the vehicle 4 cannot get over (hereinafter referred to as “obstacle 100”). In the contactless power transmission system 1, contactless power transmission for transmitting power in a contactless manner is performed between the ground-side unit 20 and the vehicle-side unit 40, using magnetic coupling between coils of, for example, a magnetic resonance method or an electromagnetic induction method.

The contactless power transmission includes power transmission from the ground-side unit 20 to the vehicle-side unit 40 and power transmission from the vehicle-side unit 40 to the ground-side unit 20. The power transmission from the ground-side unit 20 to the vehicle-side unit 40 corresponds to charging of a battery BATT mounted on the vehicle 4, and the power transmission from the vehicle-side unit 40 to the ground-side unit 20 corresponds to power supply from the battery BATT to the outside of the vehicle 4.

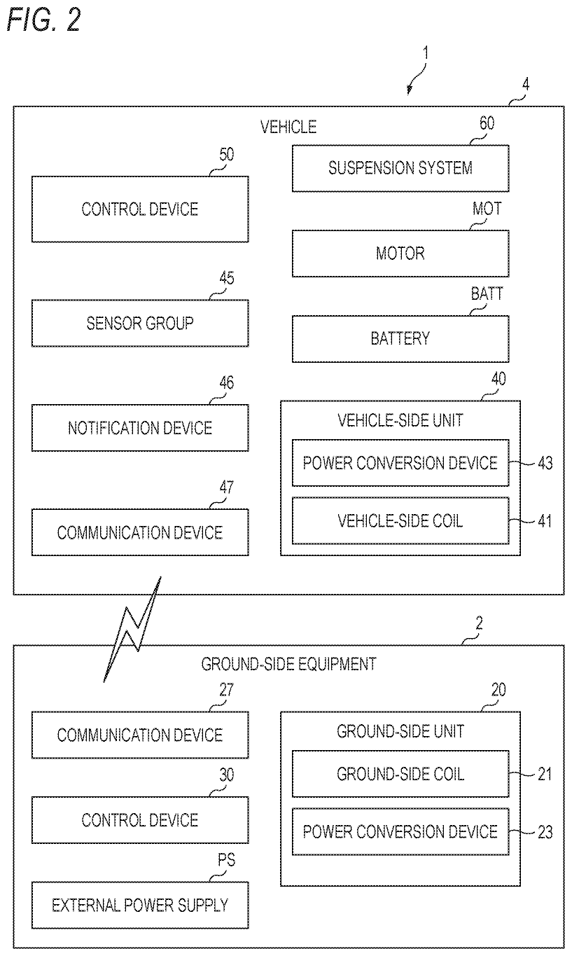

The ground-side equipment 2 is provided in a predetermined parking space or the like. As shown in FIG. 2, the ground-side equipment 2 includes the ground-side unit 20, a communication device 27 that can communicate with the vehicle 4, a control device 30 that controls the ground-side unit 20, and a power supply device PS connected to an external power system such as a commercial power supply.

The ground-side unit 20 includes a ground-side coil 21 provided on the ground, a resin pad 22 covering the ground-side coil 21, and a power conversion device 23 that converts AC power supplied from the power supply device PS into high-frequency AC power and supplies the converted high-frequency AC power to the ground-side coil 21. A shape of the ground-side coil 21 is, for example, circular in a plan view, but is not limited thereto and may be elliptical, square, or rectangular.

The communication device 27 is a communication interface that performs wireless communication with a communication device 47 of the vehicle 4. For the wireless communication, for example, Wi-Fi (registered trademark) or Bluetooth (registered trademark) can be used.

The control device 30 includes, for example, a processor and a memory, and performs overall control of the ground-side equipment 2. The processor is configured as one or a plurality of electric circuits in which circuit elements such as semiconductor elements are combined. The memory functions as a storage unit and includes a random access memory (RAM) required for operating the processor, a read only memory (ROM) that stores programs and data, and the like.

The vehicle 4 is an electric vehicle whose battery BATT can be charged by power supplied from the outside, and is, for example, a battery electric automobile or a plug-in hybrid vehicle. When the battery BATT is charged, the vehicle-side unit 40 receives power transmitted from the ground-side unit 20 in a contactless manner and stores the received power in the battery BATT. The battery BATT is, for example, a lithium ion battery or a nickel-metal hydride battery. The vehicle 4 can travel by driving a motor MOT, which is a drive source, using the power stored in the battery BATT. The vehicle 4 may be allowed to supply the power stored in the battery BATT to the outside. Specifically, the vehicle 4 may transmit power from the vehicle-side unit 40 to the ground-side unit 20 in a contactless manner.

The vehicle 4 has an autonomous parking function for autonomously moving to and parking in a predetermined parking space. The autonomous parking function operates, for example, in response to a request from an occupant. When the autonomous parking function is operated in the vicinity of the parking space where the ground-side equipment 2 is provided, the vehicle 4 autonomously moves toward a target parking position. A parking position where power transmission efficiency is maximized is a position where centers of the ground-side unit 20 and the vehicle-side unit 40 are aligned with each other, and the vehicle 4 basically sets this position where the power transmission efficiency is maximized as the target parking position and autonomously moves.

As shown in FIGS. 1 and 2, the vehicle 4 includes the battery BATT, the motor MOT serving as the drive source, the vehicle-side unit 40, a sensor group 45, a notification device 46, the communication device 47, a suspension system 60, and a control device 50.

The vehicle-side unit 40 includes a vehicle-side coil 41 mounted on a lower portion of the vehicle 4, a resin pad 42 covering the vehicle-side coil 41, and a power conversion device 43. A shape of the vehicle-side coil 41 is, for example, circular in a plan view, but is not limited thereto and may be elliptical, square, or rectangular.

The power conversion device 43 is implemented as an inverter including a switching element such as a transistor. For example, when the battery BATT is charged, the power conversion device 43 rectifies high-frequency AC power received by the vehicle-side coil 41 and outputs the rectified AC power to the battery BATT. When power is transmitted from the battery BATT to the outside of the vehicle 4, the power conversion device 43 converts DC power of the battery BATT into high-frequency AC power and supplies the AC power to the vehicle-side coil 41.

The sensor group 45 acquires various detection values used for controlling the vehicle 4. The sensor group 45 includes, for example, a camera (image sensor) and a sonar for acquiring surrounding information of the vehicle 4. The sensor group 45 also includes, for example, a vehicle height sensor, a wheel sensor, a positioning sensor, and a steering angle sensor for acquiring state information on the vehicle 4. The sensor group 45 may also include other sensors, for example, radar and light detection and ranging (LiDAR) for acquiring the surrounding information of the vehicle 4.

The sensor group 45 may further include a sensor that can detect the occupant in the vehicle. For example, the sensor group 45 includes a camera that can capture an image of the inside of the vehicle or a seating sensor provided in a seat.

The notification device 46 is an output destination of notification processing by the control device 50, and notifies the occupant of the vehicle 4 of predetermined information. The notification device 46 is, for example, a display (also including a head-up display) or a speaker provided in the vehicle 4, and notifies the occupant of the predetermined information by video or audio. The notification device 46 may also be a user terminal such as a smartphone or a tablet terminal owned by the occupant.

The communication device 47 is a communication interface that performs wireless communication with the communication device 27 of the ground-side equipment 2. For the wireless communication, for example, Wi-Fi (registered trademark) or Bluetooth (registered trademark) can be used. The communication device 47 can also perform wireless communication via a network using a mobile communication network such as “4G” or “5G”.

The suspension system 60 includes suspensions 62 disposed between wheels W and a vehicle body B. In the present embodiment, the wheels W are left and right front wheels and left and right rear wheels, and a total of four suspensions 62 are provided corresponding to the respective wheels W. Each suspension 62 is supported by the vehicle body B via a suspension arm 61. Various types of suspensions can be used as the suspension 62, and in the present specification, an air suspension extendable and contractible by compressed air is described as an example.

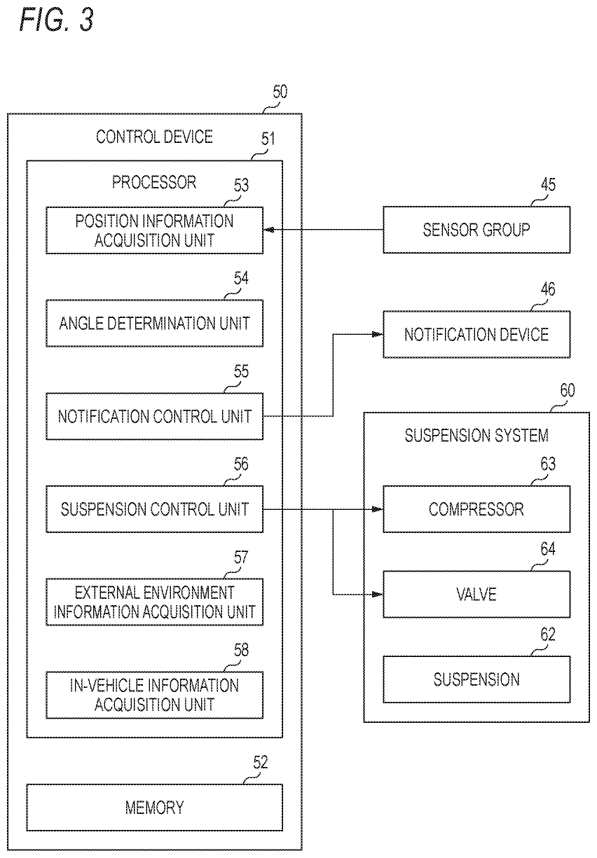

As shown in FIG. 3, the suspension system 60 further includes a compressor 63 that generates compressed air and supplies the compressed air to the suspension 62, and a valve 64 that is provided corresponding to each suspension 62 and can switch between opening and closing. The compressor 63 and the valve 64 operate under control of the control device 50 to adjust a degree of extension and contraction (air pressure) of the suspension 62. When the compressed air is supplied to the suspension 62, a vehicle height of the vehicle 4 increases, and when the compressed air inside the suspension 62 is released, the vehicle height of the vehicle 4 decreases.

The control device 50 is, for example, an electronic control unit (ECU) including a processor 51 and a memory 52. The processor 51 is configured as one or a plurality of electric circuits in which circuit elements such as semiconductor elements are combined. The memory 52 functions as a storage unit and includes a RAM required for operating the processor 51, a ROM that stores programs and data, and the like.

The processor 51 includes, as functional configurations implemented by reading and executing a program stored in the memory 52, a position information acquisition unit 53, an angle determination unit 54, a notification control unit 55, a suspension control unit 56, an external environment information acquisition unit 57, and an in-vehicle information acquisition unit 58. A plurality of processors 51 may be provided by being subdivided into various functions.

The position information acquisition unit 53 acquires information on a relative position between the vehicle-side unit 40 and the ground-side unit 20 based on, for example, an image captured by the camera in the sensor group 45. When the ground-side unit 20 is located under a floor of the vehicle 4 and an image of the ground-side unit 20 cannot be captured by the camera, the position information acquisition unit 53 estimates the relative position between the vehicle-side unit 40 and the ground-side unit 20, for example, with reference to an operation amount of a steering operation, a drive operation, or a brake operation.

When the vehicle-side unit 40 is tilted with respect to the ground-side unit 20 by tilt control to be described later, the angle determination unit 54 determines a target angle based on the relative position between the vehicle-side unit 40 and the ground-side unit 20.

The notification control unit 55 issues a predetermined notification to the occupant via the notification device 46.

The suspension control unit 56 controls the compressor 63 and the valve 64 to change the air pressure of the suspension 62 and change a stroke (length) of the suspension 62. In the present specification, controlling the compressor 63 and the valve 64 may be referred to as controlling the suspension 62.

The external environment information acquisition unit 57 acquires external environment information on the vehicle 4 from, for example, the camera or the sonar in the sensor group 45. For example, the external environment information acquisition unit 57 acquires position information on the ground-side unit 20 and the obstacle 100.

The in-vehicle information acquisition unit 58 acquires in-vehicle information from, for example, the seating sensor or the camera that can capture an image of the inside of the vehicle in the sensor group 45. For example, the in-vehicle information acquisition unit 58 acquires information indicating whether there is an occupant in the vehicle.

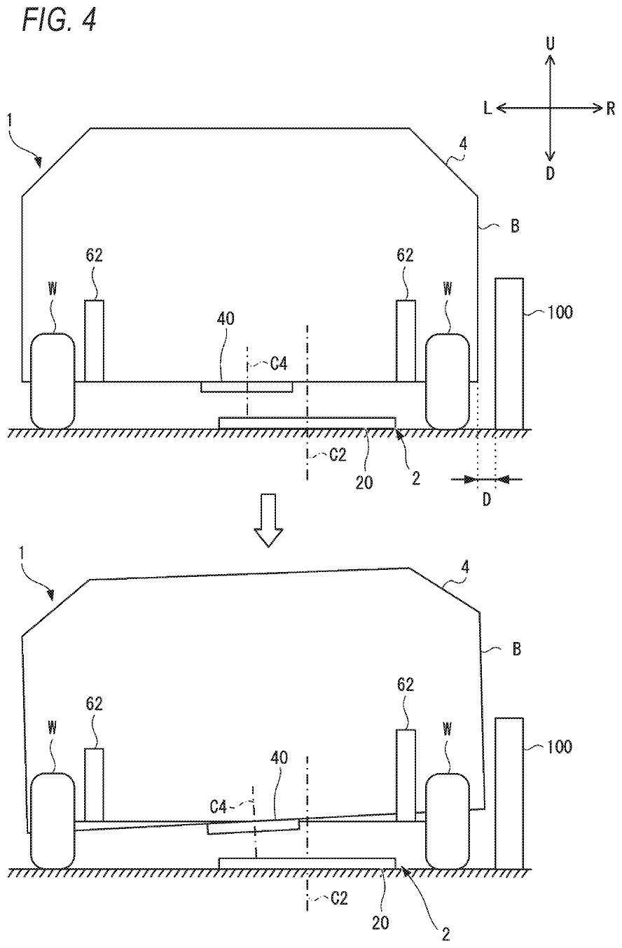

As shown in upper diagrams in FIGS. 1 and 4, when the obstacle 100 such as a wall is present in the vicinity of the parking space where the ground-side equipment 2 is provided, there may be a case where a central axis C2 of the ground-side unit 20 and a central axis C4 of the vehicle-side unit 40 cannot be aligned with each other in a top view. When the vehicle 4 is parked in such a parking space, it is required to park the vehicle 4 while being deviated in a direction parallel to the ground (that is, a horizontal direction) from the target parking position where the central axis C2 of the ground-side unit 20 and the central axis C4 of the vehicle-side unit 40 are aligned with each other. When the contactless power transmission is performed in the state in which the relative position between the ground-side unit 20 and the vehicle-side unit 40 deviates from the target parking position, power transmission efficiency decreases as compared to a case where the contactless power transmission is performed at the target parking position.

Therefore, as shown in a lower diagram of FIG. 4, the processor 51 of the control device 50 controls the suspension 62 to tilt the vehicle-side unit 40 with respect to the ground-side unit 20. Hereinafter, this control is also referred to as “tilt control”. The processor 51 tilts the vehicle-side unit 40 such that a virtual intersection between the ground-side unit 20 and the central axis C4 of the vehicle-side unit 40 approaches the central axis C2 of the ground-side unit 20. Specifically, in the example shown in FIG. 4, the processor 51 controls each suspension 62 by adjusting the air pressure of each suspension 62 such that the compressed air is released from the suspension 62 supporting the left wheel W to contract the suspension 62 and/or the compressed air is supplied to the suspension 62 supporting the right wheel W to extend the suspension 62.

By such tilt control, even in a state in which the ground-side unit 20 and the vehicle-side unit 40 deviate from each other, the power transmission efficiency can be improved as compared to a case where the tilt control is not performed. In addition, since the tilt of the vehicle-side unit 40 with respect to the ground-side unit 20 can be implemented by the suspension 62, it is not required to provide an additional mechanism.

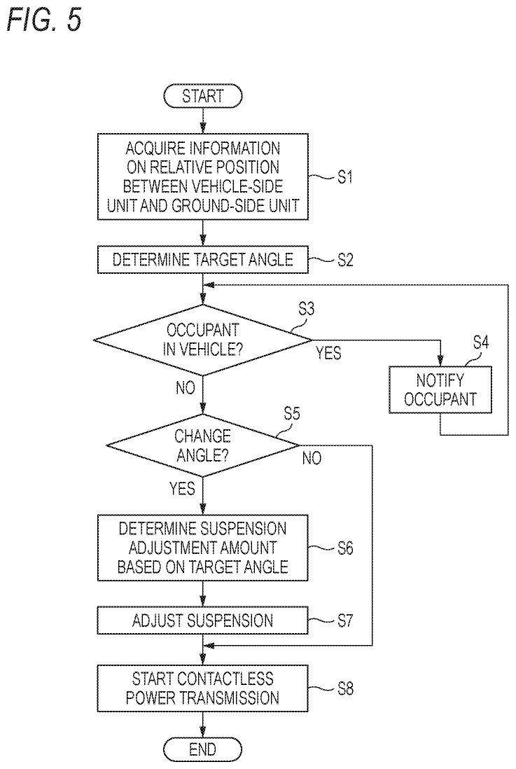

FIG. 5 is a flowchart showing an example of the tilt control by the processor 51. Processing of the tilt control is executed continuously after the parking of the vehicle 4 is completed.

First, the processor 51 acquires the information on the relative position between the vehicle-side unit 40 and the ground-side unit 20 (step S1). For example, the processor 51 acquires information related to a relative position of the ground-side unit 20 with respect to the vehicle-side unit 40 or a relative position of the vehicle-side unit 40 with respect to the ground-side unit 20.

The processor 51 determines the target angle of the vehicle-side unit 40 with respect to the ground-side unit 20 based on the relative position between the vehicle-side unit 40 and the ground-side unit 20 (step S2). As described above, the target angle is an angle at which the virtual intersection between the ground-side unit 20 and the central axis C4 of the vehicle-side unit 40 approaches the central axis C2 of the ground-side unit 20, and is an angle at which the power transmission efficiency increases. The processor 51 determines the target angle by calculation or by referring to a map indicating a relationship between the relative position and the angle. Since the processor 51 determines the target angle based on the relative position between the vehicle-side unit 40 and the ground-side unit 20, the power transmission efficiency can be improved as compared to a case where the vehicle-side unit 40 is tilted at a constant angle regardless of the relative position.

In step S2, for example, the processor 51 may determine the target angle to be zero when it is expected that the power transmission efficiency is hardly changed or only slightly increased, as compared to a case without tilting, even when the vehicle-side unit 40 is tilted with respect to the ground-side unit 20. Specifically, when a rate of increase in the power transmission efficiency is expected to be less than a predetermined value, the processor 51 may determine the target angle to be zero.

The processor 51 determines whether there is an occupant in the vehicle (step S3). For example, the processor 51 determines whether there is an occupant in the vehicle based on a detection value of the seating sensor or the camera that can capture an image of the inside of the vehicle in the sensor group 45. The processor 51 may determine whether there is an occupant in the vehicle based on information transmitted from the user terminal. The processor 51 determines that there is no occupant in the vehicle when information indicating that the occupant has exited the vehicle is received from the user terminal.

When it is determined that there is an occupant in the vehicle (step S3: YES), the processor 51 issues a predetermined notification to the occupant (step S4), and returns to step S3 after the notification. The processor 51 uses the notification device 46 to notify, by video or audio, the occupant of, for example, information prompting the occupant to exit the vehicle. On the other hand, when it is determined that there is no occupant in the vehicle (step S3: NO), the processor 51 allows the vehicle-side unit 40 to be tilted, and proceeds to step S5. According to such a configuration, it is possible to prevent the processing of tilting the vehicle-side unit 40 from being executed in a state in which the occupant is on board, and to ensure safety of the occupant.

When it is determined that there is no occupant in the vehicle (step S3: NO), the processor 51 determines whether to tilt the vehicle-side unit 40 by changing an angle of the vehicle-side unit 40 with respect to the ground-side unit 20 (step S5).

When the target angle is determined to be zero in step S2, the processor 51 determines that the vehicle-side unit 40 is not to be tilted (step S5: NO), magnetically couples the ground-side coil 21 and the vehicle-side coil 41, and starts the contactless power transmission (step S8).

When it is determined that the vehicle-side unit 40 is to be tilted (step S5: YES), the processor 51 determines an adjustment amount of the suspension 62 based on the target angle (step S6). The adjustment amount of the suspension 62 is, for example, the air pressure supplied to the suspension 62. In the present embodiment, since four suspensions 62 are provided, the respective air pressures are determined.

The processor 51 adjusts the suspension 62 based on the determined adjustment amount of the suspension 62 (step S7). Specifically, the processor 51 controls the compressor 63 and the valve 64 to adjust the suspension 62. Accordingly, the vehicle-side unit 40 is tilted at the target angle with respect to the ground-side unit 20.

After the adjustment of the suspension 62 is completed, the processor 51 magnetically couples the ground-side coil 21 and the vehicle-side coil 41 to start the contactless power transmission (step S8). In this way, since the vehicle-side unit 40 is tilted with respect to the ground-side unit 20 before starting the contactless power transmission, the power transmission can be performed with high transmission efficiency from when the contactless power transmission is started.

Regarding the determination of the target angle (step S2) or the determination of the adjustment amount of the suspension 62 (step S6) described above, the processor 51 may determines the target angle or the adjustment amount of the suspension 62 based on a relative position between the obstacle 100 and the vehicle 4.

Specifically, the processor 51 acquires position information on the obstacle 100 based on a detection value of the camera, the sonar, or the like in the sensor group 45. The processor 51 calculates a distance D between the obstacle 100 and the vehicle 4 when the parking is completed based on the position information on the obstacle 100, and determines the target angle or the adjustment amount of the suspension 62 within a range in which the vehicle 4 does not come into contact with the obstacle 100 due to the control of the suspension 62. Thus, the suspension 62 can be safely controlled.

When the distance D between the obstacle 100 and the vehicle 4 when the parking is completed is less than a predetermined distance and the reference sign 100 and the vehicle 4 are fairly close to each other, the processor 51 may determine the target angle or the adjustment amount of the suspension 62 to be zero, in other words, may not control the suspension 62.

The various types of processing in the flowcharts described above can be implemented by executing a program prepared in advance by a computer, specifically, the processor 51. The program is stored in a computer-readable storage medium and executed by being read from the storage medium. In addition, the program may be provided in a form stored in a non-transitory storage medium such as a flash memory, or may be provided via a network.

### First Modification

In the above-described embodiment, when it is determined that there is an occupant in the vehicle, the processor 51 is configured to wait until the occupant disappears from the vehicle, but the present invention is not limited thereto. As an example, in a case where the occupant is in the vehicle even after a predetermined time elapses since the notification to the occupant, the processor 51 may proceed to step S8 without controlling the suspension 62 and start the contactless power transmission. As another example, even when information indicating that the occupant continues to be on board is acquired after the notification to the occupant, the processor 51 may proceed to step S8 without controlling the suspension 62 and start the contactless power transmission.

### Second Modification

In the above-described embodiment, the processor 51 executes the processing of tilting the vehicle-side unit 40 with respect to the ground-side unit 20 before starting the contactless power transmission, but the present invention is not limited thereto. For example, the processor 51 may control the suspension 62 to tilt the vehicle-side unit with respect to the ground-side unit 20 during the contactless power transmission. In this case, the processor 51 may search for an optimal angle that is an angle at which the power transmission efficiency is maximized while controlling the suspension 62. Accordingly, the contactless power transmission with high transmission efficiency can be implemented.

Although one embodiment of the present disclosure has been described above with reference to the accompanying drawings, it is needless to say that the present invention is not limited to the embodiment. It is apparent to those skilled in the art that various changes or modifications can be conceived within the scope described in the claims, and it is understood that the changes or modifications naturally fall within the technical scope of the present invention. In addition, the constituent elements in the above embodiments may be freely combined without departing from the gist of the invention.

For example, in the above-described embodiment, an example has been described in which the relative position between the vehicle-side unit 40 and the ground-side unit 20 deviates from the target parking position due to the obstacle 100 present around the vehicle 4, but the present invention is not limited thereto. For example, the deviation of the relative position between the vehicle-side unit 40 and the ground-side unit 20 may be caused by manually parking the vehicle 4 in the parking space by an operation of a driver instead of the autonomous parking.

In the present specification, at least the following matters are described. In the parentheses, the corresponding constituent elements and the like in the above embodiment are shown as examples, but the present invention is not limited thereto.

(1) A vehicle (vehicle 4) for a contactless power transmission system (contactless power transmission system 1) that performs contactless power transmission between a vehicle-side unit (vehicle-side unit 40) mounted on the vehicle and a ground-side unit (ground-side unit 20) provided outside the vehicle, the vehicle including:
a battery (battery BATT);
the vehicle-side unit electrically connected to the battery;
a suspension (suspensions 62) disposed between a wheel (wheels W) and a vehicle body (vehicle body B); and
a control device (control device 50) including a processor (processor 51) that controls the vehicle-side unit and the suspension, in which
the processor
   acquires information on a relative position between the vehicle-side unit and the ground-side unit (step S1), and
   controls the suspension to tilt the vehicle-side unit with respect to the ground-side unit when the relative position deviates from a predetermined target position (target parking position) (step S7).

According to (1), for example, even when a center of the vehicle-side unit and a center of the ground-side unit cannot be aligned with each other due to an object around the vehicle, power transmission efficiency can be improved by tilting the vehicle-side unit with respect to the ground-side unit. In addition, since the tilt of the vehicle unit can be implemented by the suspension of the vehicle, it is not required to provide an additional mechanism.

(2) The vehicle for the contactless power transmission system according to (1), in which
the processor
   determines a target angle of the vehicle-side unit with respect to the ground-side unit based on the relative position (step S2), and
   controls the suspension based on the target angle to tilt the vehicle-side unit with respect to the ground-side unit.

According to (2), since the target angle is determined based on the relative position between the vehicle-side unit and the ground-side unit, the power transmission efficiency can be further improved as compared to a case where the vehicle-side unit is tilted at a constant angle regardless of the relative position.

(3) The vehicle for the contactless power transmission system according to (1) or (2), further including
a detector (sensor group 45) configured to detect an object (obstacle 100) around the vehicle, in which
the processor controls the suspension based on a relative position between the object detected by the detector and the vehicle to tilt the vehicle-side unit with respect to the ground-side unit.

According to (3), it is possible to prevent the vehicle from coming into contact with a surrounding object by controlling the suspension, and to safely control the suspension.

(4) The vehicle for the contactless power transmission system according to any of (1) to (3), in which the processor controls the suspension to tilt the vehicle-side unit with respect to the ground-side unit after determining that there is no occupant in the vehicle.

According to (4), it is possible to prevent the processing of tilting the vehicle-side unit from being executed in a state in which the occupant is on board, and to ensure safety of the occupant.

(5) The vehicle for the contactless power transmission system according to any of (1) to (4), in which
the processor controls the suspension to tilt the vehicle-side unit with respect to the ground-side unit before starting the contactless power transmission.

According to (5), it is possible to perform power transmission with high transmission efficiency from when the contactless power transmission is started.

(6) The vehicle for the contactless power transmission system according to (1), in which
the processor controls the suspension to tilt the vehicle-side unit with respect to the ground-side unit and searches for an optimal angle of the vehicle-side unit with respect to the ground-side unit for the contactless power transmission during the contactless power transmission.

According to (6), the contactless power transmission with high transmission efficiency can be implemented.

(7) A control method for a contactless power transmission system that transmits power in a contactless manner between a vehicle-side unit mounted on a vehicle and a ground-side unit provided outside the vehicle, the control method including:
acquiring, by a processor, information on a relative position between the vehicle-side unit and the ground-side unit; and
controlling, by the processor, a suspension of the vehicle to tilt the vehicle-side unit with respect to the ground-side unit when the relative position deviates from a predetermined target position.

According to (7), for example, even when a center of the vehicle-side unit and a center of the ground-side unit cannot be aligned with each other due to an object around the vehicle, power transmission efficiency can be improved by tilting the vehicle-side unit with respect to the ground-side unit. In addition, since the tilt of the vehicle unit is implemented using the suspension of the vehicle, it is not required to provide an additional mechanism.

(8) A non-transitory computer-readable storage medium storing a program for a contactless power transmission system causing a computer to perform processing, the contactless power transmission system transmitting power in a contactless manner between a vehicle-side unit mounted on a vehicle and a ground-side unit provided outside the vehicle, the processing including:
acquiring information on a relative position between the vehicle-side unit and the ground-side unit; and
controlling a suspension of the vehicle to tilt the vehicle-side unit with respect to the ground-side unit when the relative position deviates from a predetermined target position.

According to (8), for example, even when a center of the vehicle-side unit and a center of the ground-side unit cannot be aligned with each other due to an object around the vehicle, power transmission efficiency can be improved by tilting the vehicle-side unit with respect to the ground-side unit. In addition, since the tilt of the vehicle unit is implemented using the suspension of the vehicle, it is not required to provide an additional mechanism.

What is claimed is:

1. A vehicle for a contactless power transmission system that performs contactless power transmission between a vehicle-side unit mounted on the vehicle and a ground-side unit provided outside the vehicle, the vehicle comprising:
a battery;
the vehicle-side unit electrically connected to the battery;
a suspension disposed between a wheel and a vehicle body; and
a control device including a processor that controls the vehicle-side unit and the suspension, wherein
the processor
acquires information on a relative position between the vehicle-side unit and the ground-side unit, and
controls the suspension to tilt the vehicle-side unit with respect to the ground-side unit when the relative position deviates from a predetermined target position.

2. The vehicle for the contactless power transmission system according to claim 1, wherein
the processor
determines a target angle of the vehicle-side unit with respect to the ground-side unit based on the relative position, and
controls the suspension based on the target angle to tilt the vehicle-side unit with respect to the ground-side unit.

3. The vehicle for the contactless power transmission system according to claim 1, further comprising
a detector configured to detect an object around the vehicle, wherein
the processor controls the suspension based on a relative position between the object detected by the detector and the vehicle to tilt the vehicle-side unit with respect to the ground-side unit.

4. The vehicle for the contactless power transmission system according to claim 1, wherein
the processor controls the suspension to tilt the vehicle-side unit with respect to the ground-side unit after determining that there is no occupant in the vehicle.

5. The vehicle for the contactless power transmission system according to claim 1, wherein
the processor controls the suspension to tilt the vehicle-side unit with respect to the ground-side unit before starting the contactless power transmission.

6. The vehicle for the contactless power transmission system according to claim 1, wherein
the processor controls the suspension to tilt the vehicle-side unit with respect to the ground-side unit and searches for an optimal angle of the vehicle-side unit with respect to the ground-side unit for the contactless power transmission during the contactless power transmission.

7. A control method for a contactless power transmission system that transmits power in a contactless manner between a vehicle-side unit mounted on a vehicle and a ground-side unit provided outside the vehicle, the control method comprising:
acquiring, by a processor, information on a relative position between the vehicle-side unit and the ground-side unit; and
controlling, by the processor, a suspension of the vehicle to tilt the vehicle-side unit with respect to the ground-side unit when the relative position deviates from a predetermined target position.

8. A non-transitory computer-readable storage medium storing a program for a contactless power transmission system causing a computer to perform processing, the contactless power transmission system transmitting power in a contactless manner between a vehicle-side unit mounted on a vehicle and a ground-side unit provided outside the vehicle, the processing comprising:
acquiring information on a relative position between the vehicle-side unit and the ground-side unit; and
controlling a suspension of the vehicle to tilt the vehicle-side unit with respect to the ground-side unit when the relative position deviates from a predetermined target position.
